(19) United States
(12) Patent Application Publication
(10) Pub. No.: US 2010/0018369 A1
(43) Pub. Date: Jan. 28, 2010

(54) METHOD AND SYSTEM FOR THIN CUTTING

(76) Inventor: Arnon Lavi, Moshav Shilat (IL)

Correspondence Address: Pearl Cohen Zedek Latzer, LLP, 1500 Broadway, 12th Floor, New York, NY, 10036, US

(21) Appl. No.: 12/506,492

(22) Filed: Jul. 21, 2009

Related U.S. Application Data
(60) Provisional application No. 61/082,259, filed on Jul. 21, 2008.
(60) Provisional application No. 61/098,745, filed on Sep. 20, 2008.
(60) Provisional application No. 61/117,099, filed on Nov. 22, 2008.
(60) Provisional application No. 61/183,558, filed on Jun. 3, 2009.

(51) Int. Cl. B26D 7/08; B26D 7/06; B26D 1/00

(52) U.S. Cl. 83/14; 83/448; 83/651

(57) ABSTRACT

A method and system for thin cutting and a cutting tip, the system comprising a saw unit and a guiding unit comprising at least one pair of guides, wherein each pair is configured to impose pressure on corresponding two opposite pre-cut longitudinal edges of a block of raw material and to guide said block of raw material into said saw unit. The cutting tip for thin cutting saw comprises a cutting edge and a root of said tip, located ahead of the cutting edge in the cutting direction. The method for thin cutting comprising guiding a block of raw material into a saw unit by imposing pressure by at least one pair of guides on corresponding two opposite pre-cut longitudinal edges of a block of raw material.

### CROSS-REFERENCE TO RELATED APPLICATIONS

This application claims the benefit of U.S. Ser. No. 61/082,259, filed on Jul. 21, 2008 (and entitled Guiding and Feeding System for Cutting Machines), U.S. Ser. No. 61/098,745, filed on Sep. 20, 2008 (and entitled Method of Guiding and Cutting Thin Cutting Machines), U.S. Ser. No. 61/117,099, filed on Nov. 22, 2008 (and entitled New Method of Guiding and Cutting on Thin Cutting Machines), and U.S. Ser. No. 61/183,558, filed on Jun. 3, 2009 (and entitled Improved Cutting Tip Saw Blade) which are incorporated in their entirety herein by reference.

### BACKGROUND OF THE INVENTION

Lamellas of cut wood are largely used, for example, in the parquet and flooring industries, for production of multi-layered boards, for wood coatings etc. There are several common methods for cutting the lamellas out of a block of wood.

Some of these known methods include cutting by frame saws illustrated in FIG. 1A, i.e. a series of saw blades 16 mounted on an oscillating frame (not shown), or by band saws illustrated in FIG. 1B or by circular saws. In frame saws, groups of saws 16 are used to cut wooden blocks 18 into lamellas 19, wherein each of the groups of saws 16 is laid in between two thicker blades called scrapers 17. Scrapers 17 are used for cutting, or scraping, the external surfaces of each block 18 in order to keep the external lamellas in the same thickness as the internal lamellas. Since the thickness and the external surface of block 15 may be non-uniform, some extra width is required in the external surfaces in order that scrapers 17 may straighten and unify the external lamellas. The worse the uniformity of the thickness and external surface, the greater extra width may be required in order to straighten the external surfaces by scrapers 17. This may cause a great waste of material.

The frame saws as used in the prior art have relatively high accuracy of cut, however, their cutting speeds are relatively slow. Band saws and circular saws have higher cutting speeds, however their accuracy of cut is worse.

In all of these methods the feed direction of the wooden block must be as parallel as possible to the cutting plane of the saw blades. Any free movement in perpendicular direction may result in less accuracy, reduced cutting speeds, and excessive forces on the saw blades.

For frame saws, the existing guiding/feeding systems, illustrated in FIG. 2A, are usually based on a fence 15 which guides the wooden block 18 into the saws 16 (see FIG. 1a). The ability to cut more then two pieces simultaneously is achieved by a system called “Channel system”, illustrated in FIG. 2B, where each wooden block 18 is fed between two guiding fences 15.

For band saws, the feeding is usually done by a horizontal belt drive, on which the wooden blocks are laid, and pressed down to the belt by pressure rollers and shoes, in order to achieve accurate guiding into the saws.

The existing guiding systems are sufficiently efficient only if the wooden blocks are straight longitudinally, planed and squared. In the channel system, the straightness of wooden blocks and their accuracy in thickness is critical. For example, thinner raw material may result in thinner external lamellas, and thicker or banded material may get stuck in the channels. A precut operation of longitudinal straightening, planning and squaring of the wooden blocks is done usually on a separate machine, usually called “a four side planner” or “a molder”. This preliminary operation is considered a “must” in the existing known process of thin cutting.

The use of saw blades with cutting tips is very common in sawing machines, and in all types of saws such as circular saws, band saws, hacksaws and frame saws. The cutting tips are usually made out of a different material then the saw body. Common materials are “Stelite” (registered name), Hard Metal (HM, HW, TCT blades etc.) and PCD (Poly Crystalline Diamond).

Common cutting tips are illustrated in FIGS. 3A and 3B. Cutting tips 21 may usually be welded to saw teeth, and usually have a wider kerf than saw body thickness (to eliminate friction between the saw body and the cut surfaces).

The cutting edge of tips 21 may be of obtuse edge angle 25 as shown in FIG. 3b (for, example, to cut metals as aluminum) or acute edge angle 26 as shown in FIG. 3a (for example, to cut wood, plastics, etc.). In FIG. 3B, cutting tips 21 have negative face/cutting angle 28 and in FIG. 3A, cutting tips 21 have positive face/cutting angle 27.

Additionally, cutting tips 21 may include a side release angle 22 relative to the sawing plane, having and inclination direction \vec{3}, and a back (or top) release angle 23 relative to the cutting direction \vec{1}.

In the known prior art of thin cutting saws, the cutting tip may be pushed by the relatively flexible blade material, which may cause deviations of the cutting tip from the cutting plane.

The known cutting tips do not provide optimal cutting features, e.g., in surface quality, accuracy of cut and minimization of kerfs.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIGS. 1A and 1B are schematic illustrations of frame saws and band saws as known in the art;

FIGS. 2A and 2B are schematic illustrations of guiding systems as known in the art;

FIGS. 3A and 3B are schematic illustrations of saw cutting tips as known in the art;

FIG. 4A is a three-dimensional schematic illustration of a system for thin cutting according to embodiments of the present invention;

FIG. 4B is a cross-sectional schematic illustration of a similar system for thin cutting according to embodiments of the present invention;

FIG. 5 is a three-dimensional schematic illustration of a system without scrappers for thin cutting according to other embodiments of the present invention;

FIGS. 6A and 6B are schematic illustrations of cutting tools for molding of pre-cut grooves and guiding rebates or guiding plane respectively according to embodiments of the present invention;

FIG. 7 is a three-dimensional schematic illustration of a system for thin cutting according to embodiments of the present invention;

FIG. 8 is a three-dimensional schematic illustration of a system for thin cutting according to embodiments of the present invention;

FIG. 9 is a schematic illustration of a cutting tip according to the present invention from three angles of view;

FIG. 10 is a schematic illustration of a cutting tip according to the present invention, with alternative facet instead of the facet shown in FIG. 9; and

FIG. 11 is a schematic illustration of a cutting tip according to the present invention from three angles of view.

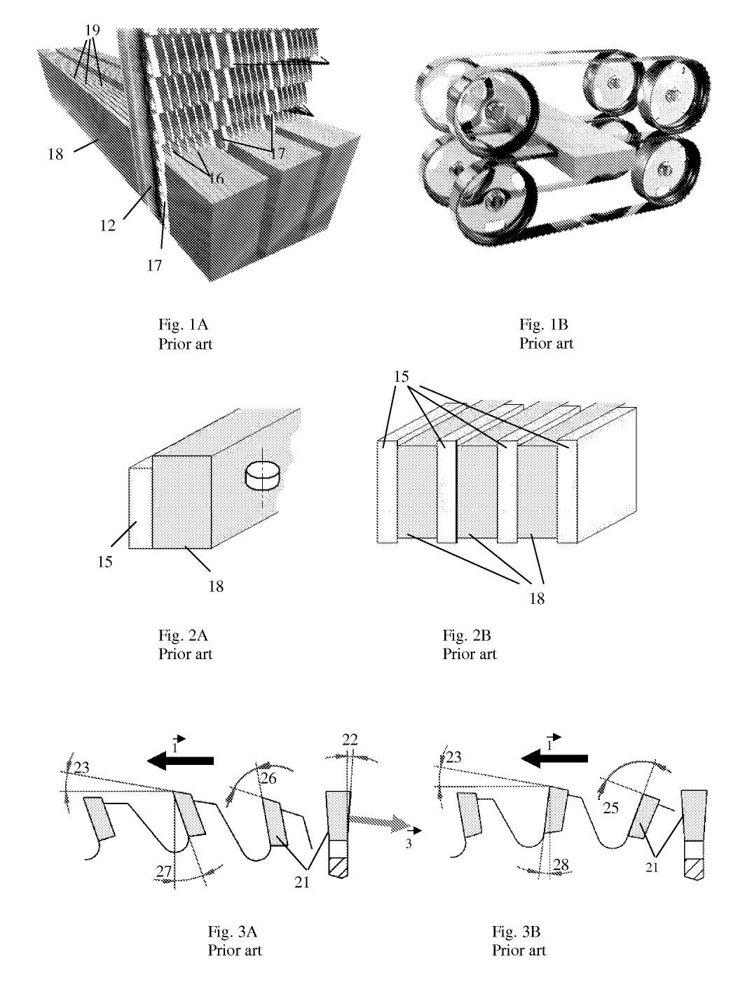

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

Embodiments of the present invention may overcome the limitations of the existing known cutting systems by enabling high feeding and cutting speeds together with high accuracy of cut. According to embodiments of the present invention, the saw blades may be forced to run in an accurate path of pre-cut grooves, and thus, for example, the cutting accuracy may be kept. Therefore, embodiments of the present invention may enable an increase in capacity and reduction in waste, for example, by increasing the cutting and feeding speeds, and/or by using elements such as, for example, thinner and longer saw blades.

Embodiments of the present invention may also provide a special form of tooth or cutting tip for thin cutting, which may facilitate a better correlation between the saw blade running path and the required cutting plane.

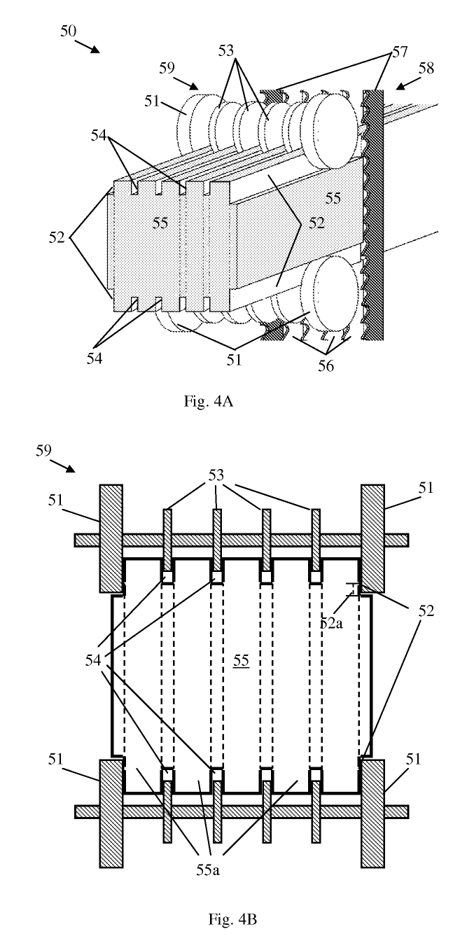

Reference is now made to FIG. 4A, which is a three-dimensional schematic illustration of a system 50 for thin cutting according to embodiments of the present invention and to FIG. 4B which is a cross-sectional schematic illustration of a similar system 50. System 50 may cut a block of raw material 55 into lamellas 55a. System 50 may include saw unit 58 and guiding/feeding unit 59. Guiding/feeding unit 59 may guide block 55 into saw unit 58. The guiding may be performed by friction at the contact points between block 55 and guiding unit 59. Guiding/feeding unit 59 may include major guides 51 and supporting guides 53. Saw unit 58 may include saw blades 56 and scrapers 57. Guides 51 and supporting guides 53 may guide and/or feed a block 55 of raw material into saw blades 56 and scrapers 57. The guiding by guiding/feeding unit 59 may reduce friction of block 55 with stationary elements, and thus, for example, may ensure less feeding problems.

Block 55 may include longitudinal pre-cut grooves 54 and rebate pre-cuts 52, which may be pre-molded in block 55. Rebate pre-cuts 52 may be produced to fit onto guides 51, for example, in the appropriate depth and/or width such that, for example, guides 51 may impose pressure on walls of rebate pre-cuts 52 and thus, for example, tightly guide block 55. Supporting guides 53 may prevent bending of material between pre-cut grooves 54, support and/or facilitate guiding of block 55. As the depth of the pre-cut grooves 54 is greater relative to the width of lamellas 55a, the tendency of the material between pre-cut grooves 54 to bend may be greater, and therefore, the importance of supporting guides 53 is greater.

In some embodiments of the present invention, guides 51 and/or supporting guides 53 may be disc-shaped. Optionally, guides 51 may rotate and thus, for example, feed and/or impel block 55 towards saw blades 56 and scrapers 57, for example, by a friction force imposed on block 55 when guides 51 rotate. Guides 51 may be driven by motors.

Pre-cut grooves 54 may outline and/or direct to a required cutting path within block 55. Pre-cut grooves 54 may lead saw blades 56 so that, for example, saw blades 56 may follow a required cutting path with high accuracy. Pre-cut grooves 54 may prevent saw blades 56 from breaking the comers at the outgoing side of saw blades and/or damage the uniformity of surfaces of the cut lamellas 55a. Therefore, pre-cut grooves 54 may make any further planning of the lamellas after cutting unnecessary. Additionally, pre-cut grooves 54 may prepare the material for the cutting and/or serve as the first step of the cutting and thus, for example, the quantity of material which has to be removed during cutting may be reduced.

The guiding by guiding system 59 may be performed as close as possible to saw system 58. Therefore, and since the guiding may be performed “locally”, i.e. by friction at the contact points between block 55 and guiding unit 59, system 50 enables guiding and cutting of twisted and/or bended material, for example, in much higher level of curviness than allowed by known cutting system. System 50 may enable cutting of curved block 55 to curved lamellas when required.

Preferably, rebate pre-cuts 52 may be slightly deeper than pre-cut grooves 54. Guides 51 may be of greater diameter/height than supporting guides 53 so that, for example, guides 51 may reach a deeper portion 52a of rebate pre-cuts 52 and thus, for example, may perform the guiding of block 55 at deeper portion 52a. Therefore, guides 51 may impose pressure on walls of rebate pre-cuts 52 at deeper portion 52a and thus, for example, guides 51 may not bend the raw material between rebate precut 52 and precut groove 54. Therefore, the accuracy of the feeding may be improved. Additionally, guides 51 may be bigger in diameter than supporting guides 53, for example, in order that each newly coming block 55 may meet guides 51 before meeting supporting guides 53.

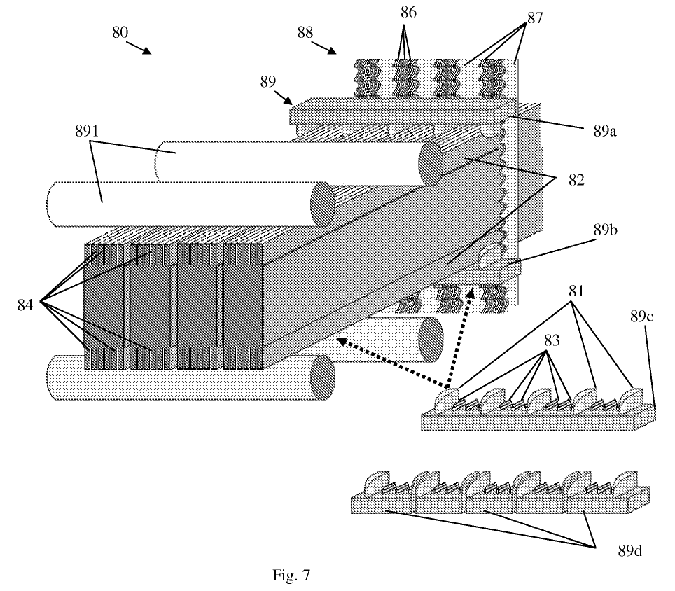

Guides 51 may be executed either as rotating discs or as stationery guiding ledges 81 and 83 as shown, for example, in FIG. 7, with similar guiding performance and guiding effect.

Scrapers 57 may cut and/or scrap the external surfaces of block 55, for example, in order to straighten and/or to keep the external cut lamellas in the same thickness as the internal cut lamellas.

Pre-cut grooves 54 and rebate pre-cuts 52 may be cut in one process, for example, by the tool described herein below with reference to FIG. 6A. The cutting in one process and preferably by the same tool may provide substantially accurate position of grooves 54 and rebate pre-cut 52. Additionally, it may provide high correlation between the positions of grooves 54 and saw blades 56.

Preferably, as shown in FIGS. 4A and 4B, pre-cut grooves 54 may be provided at two opposite sides of block 55. The width of pre-cut grooves 54 may match the width of the saw kerf (i.e. the cutting width). Accordingly, the distance between centers of grooves 54 may substantially be equal to the required thickness of the lamella plus the saw kerf.

Tight guiding by guides 51 may drastically reduce and/or substantially prevent undesired freedom of block 55 within guiding unit 59, and therefore, for example, high accuracy may be achieved. The accurate guiding may reduce the extra width required for scraping by scrapers 57 in order to make the external cut lamellas in a uniform width, which may reduce the amount of material wasted. In some embodiments, due to the high accuracy of guiding, the necessity of scrapers 57 may be eliminated. Since tensioning the scrapers 57 typically apply high forces on the saws frame, taking out scrapers 57 may increase the forces designated to tension the saws 56, thus, for example, higher tension of blades and/or higher quantity of blades and/or longer blades become now possible and all the above are means that may increase cutting capacity of saw unit 58.

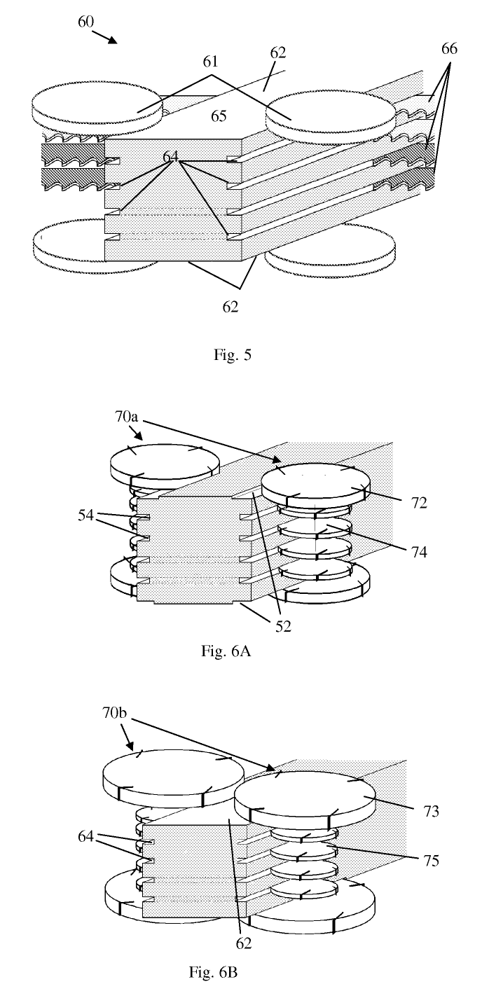

Reference is now made to FIG. 5, which is a three-dimensional schematic illustration of a system 60 without scrappers for thin cutting according to other embodiments of the present invention. System 60 may be used in combination with band saws, frame saws, or any other suitable kind of saws. System 60 may include guides 61 and saws 66. Guides 61 may guide block 65 having longitudinal pre-cut grooves 64, into saws 66 which may cut block 65 to lamellas according to pre-cut grooves 64.

Pre-cut grooves 64 may be pre-molded in block 65, for example, together with planing of planed external surfaces 62. Guides 61 may impose pressure on longitudinal edges of planed external surfaces 62 and thus, for example, may tightly guide block 65.

In some embodiments of the present invention, guides 61 may be disc-shaped. Optionally, guides 61 may rotate and thus, for example, feed and/or impel block 65 towards saw blades 66, for example, by a friction force imposed on block 65 when guides 61 rotate. Guides 61 may be driven by motors.

Pre-cut grooves 64 may outline and/or direct to a required cutting path within block 65. Pre-cut grooves 64 may lead saw blades 66 so that, for example, saw blades 66 may follow a required cutting path with high accuracy. Additionally, pre-cut grooves 64 may prepare the material for the cutting and/or serve as the first step of the cutting and thus, for example, the quantity of material which has to be removed during cutting may be reduced.

Preferably, guides 61 may be of greater diameter/height than grooves 64 so that, for example, guides 61 may reach a deeper portion of external surfaces 62 than grooves 64 and thus, for example, may perform the guiding of block 65 substantially without bending the raw material between pre-cut grooves 64 and guides 61. Therefore, the accuracy of the feeding may be improved.

Reference is now made to FIGS. 6A and 6B, which are schematic illustrations of cutting tools 70a and 70b for molding of pre-cuts. Tool 70a may include rebate cutters 72 and groove cutters 74 which may include, for example, circular saws. Rebate cutters 72 may mold, for example, rebate pre-cuts 52 described above with reference to FIGS. 4A and 4B. Groove cutters or saws 74 may mold, for example, pre-cut grooves 54 described above with reference to FIGS. 4A and 4B.

Tool 70b may include planers 73 and groove cutters or saws 75. Planers 73 may plane external surfaces 62 described above with reference to FIG. 5. Planers 73 may preferably plane external surfaces 62 to the final level of uniformity and/or to the final required width of the corresponding lamellas, for example so that external surfaces 62 may constitute the final surfaces of the corresponding lamellas. Therefore, for example, no further cutting may be needed upon external surfaces 62. Alternatively, the planing of surfaces 62 may be performed by a separate tool.

Reference is now made to FIG. 7, which is a three-dimensional schematic illustration of a system 80 for thin cutting according to embodiments of the present invention. System 80 may cut blocks of raw material 85 into lamellas. System 80 may include saw unit 88 and guiding/feeding unit 89. Guiding/feeding unit 89 may guide blocks 85 into saw unit 88. The guiding may be performed by friction at the contact points between blocks 85 and guiding unit 89. Guiding/feeding unit 89 may include major guides 81 and supporting guides 83. Saw unit 88 may include saw blades 86 and scrapers 87. Guides 81 and supporting guides 83 may guide and/or feed blocks 85 of raw material into saw blades 86 and scrapers 87 and/or function similarly to guides 51 or 61 and supporting guides 53 described above, respectively.

Blocks 85 may include pre-cut grooves 84 and rebate pre-cuts 82, which may be pre-molded in block 85 and function similarly to pre-cut grooves 54 or 64 and rebate pre-cuts 52 described above with reference to FIGS. 4A, 4B, 5, 6A and 6B, respectively.

The surrounding borders of guides 81 and supporting guides 83 may be narrowed for easy installation of blocks 85 onto Guiding/feeding unit 89.

Preferably, and similarly to rebate pre-cuts 52, rebate pre-cuts 82 may be slightly deeper than pre-cut grooves 84. Guides 81 may be of greater height than supporting guides 83 so that, for example, guides 81 may reach a deeper portion of rebate pre-cuts 82 and thus, for example, may perform the guiding of block 85 at the deeper portion of rebate pre-cuts 82. Additionally, Guides 81 may be of greater length than supporting guides 83, for example, in order that each newly coming block 85 may meet guides 81 before meeting supporting guides 83.

Guiding/feeding unit 89 may include exchangeable guiding sub-units 89a, 89b and 89c. Sub-units 89a, 89b and 89c may be exchangeable with other guiding/feeding units, for example, with different distance between supporting guides 83 and/or guides 81. Additionally, Sub-units 89a, 89b and 89c may be exchangeable with other guiding/feeding units, for example, with different width, height and/or size of supporting guides 83 and/or guides 81. Guiding sub-units may be built up from segments 89d to be adjustable accurately according to the specific position of each saw group 86 and 87.

Sub-units 89a and 89b may be mounted on two sides of block 85, for example, on the sides substantially perpendicular to the cutting planes of saw blades 86 and/or sufficiently close to saw unit 88, for example, in order to ensure accurate positioning of pre-cut grooves 84 and rebate precuts 82 relative to saw blades 86 and scrapers 87, respectively.

Sub unit 89c may be mounted on one of the two sides of block 85 which may be substantially perpendicular to the cutting planes of saw blades 86 and/or further from saw unit 88 than sub-units 89a and 89b, for example, in order to ensure the aligning of blocks 85 with the cutting planes of saws 86. It possible to mount additional guiding sub-units, however, this may not be advisable as additional guiding sub-units may limit the possibility to work with twisted and/or curved materials.

Additionally, in some embodiments of the present invention, system 80 may include pressure/feeding rollers 891, which may facilitate feeding of block 85 towards saw unit 88, support the weight of board and/or absorb/eliminate vibrations of board 85 parallel to the cutting planes of saws 86.

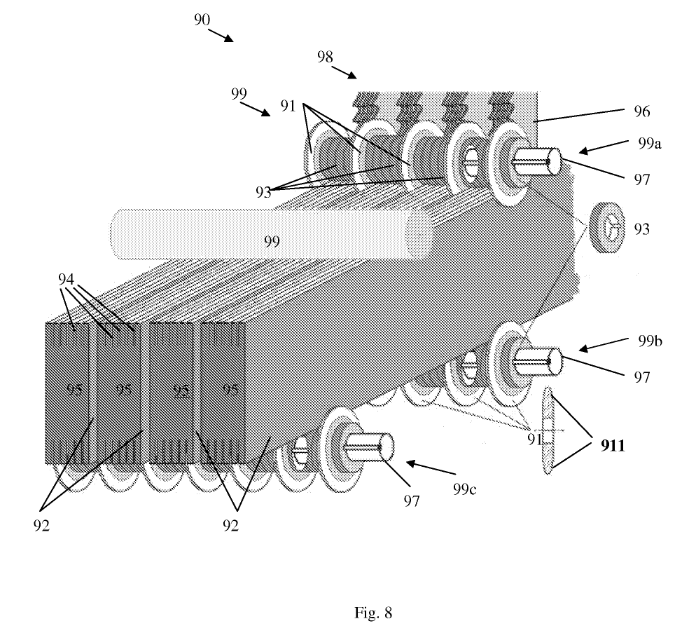

Reference is now made to FIG. 8, which is a three-dimensional schematic illustration of a system 90 for thin cutting according to embodiments of the present invention. System 90 may cut blocks of raw material 95 into lamellas. System 90 may include saw unit 98 and guiding/feeding unit 99. Saw unit 98 may include saw blades 96. Guiding/feeding unit 99 may guide blocks 95 into saw unit 98. The guiding may be performed by friction at the contact points between blocks 95 and guiding unit 99. Blocks 95 may include pre-cut grooves 94 as described in detail above.

Optionally, block 95 may include rebate pre-cuts as shown and described with reference with FIGS. 4A, 4b and 7. Further optionally, Saw unit 98 may include scrapers as shown and described with reference with FIGS. 4A, 4b and 7.

Guiding/feeding unit 99 may include guides 91 which may guide and/or feed blocks 95 into saw blades 96 and/or function similarly to guides 51 or 61 described above. Guides 91 may impose pressure on longitudinal edges of planed external surfaces 92 of block 95 (or of rebate pre-cuts, if molded in block 95) and thus, for example, may tightly guide block 95. The surrounding borders 911 of guides 91 may be narrowed for easy installation of blocks 95 onto Guiding/feeding unit 99.

Additionally, guiding/feeding unit 99 may include space rings 93, which may fix a required distance between guides 91, for example in accordance with the width of blocks 95. Guides 91 and space rings 93 may be mounted on motorized shafts 97, which may rotate guides 91 and/or rings 93, for example, about a longitudinal axis of a shaft 94. As they rotate, the perimeter of space rings 93 may impose friction on block 95, and thus, for example, space rings 93 may feed and/or impel block 95 towards saw blades 96. The perimeter of space rings 93 may optionally be serrated, sticky, or covered with high friction material such as, for example, rubber, for example in order to improve the ability of space rings 93 to feed and/or impel block 95 towards saw blades 96. Feeding by space rings 93 and guides 91 may eliminate or reduce forces perpendicular to the sawing plane, thus, for example, eliminating or reducing the need of pressure shoes and fences and/or making the feeding and cutting much simpler.

Additionally or alternatively to space rings 93, other elements may be used to fix the distance between guides 91, such as, for example, threaded nuts and/or springs and/or spring rings which may absorb thickness variations of blocks 95.

Guiding/feeding unit 99 may include exchangeable guiding sub-units 99a, 99b and 99c. Sub-units 99a, 99b and 99c may be exchangeable with other guiding/feeding units, for example, with different distance between guides 91. Additionally, Sub-units 99a, 99b and 99c may be exchangeable with other guiding/feeding units, for example, with different width, height and/or size of space rings 93 and/or guides 91.

Sub-units 99a and 99b may be mounted on two sides of block 95, for example, on the sides substantially perpendicular to the cutting planes of saw blades 96 and/or sufficiently close to saw unit 98, for example, in order to ensure accurate positioning of pre-cut grooves 94 relative to saw blades 96.

Sub unit 99c may be mounted on one of the two sides of block 95 which may be substantially perpendicular to the cutting planes of saw blades 96 and/or further from saw unit 98 than sub-units 99a and 99b, for example, in order to ensure the aligning of blocks 95 with the cutting planes of saws 96. Additionally, sub unit 99c may support the weight of blocks 95. It possible to mount additional guiding sub-units, however, this may not be advisable as additional guiding sub-units may limit the possibility to work with twisted and/or curved materials.

Additionally, in some embodiments of the present invention, system 90 may include pressure/feeding rollers 991, which may facilitate feeding of block 95 towards saw unit 98 and/or absorb/eliminate vibrations of board 95 parallel to the cutting planes of saws 96.

In order to further improve the accuracy and/or uniformity of cutting, the present invention may provide cutting tips which may provide higher surface quality and accuracy of cut than prior cutting tips and minimize the needed kerfs.

Reference is now made to FIG. 9, which is a schematic illustration of cutting tip 20 according to the present invention from several angles. Cutting tip 20 may be attached to saw 28. Cutting tip 20 may be made of a stiff material relative to saw 28.

Cutting tip 20 may include positive face angle 22, negative face angle 23, a sharp cutting edge 21, tip root 24 and tip facets 25. Cutting edge 21 may be located at the edge of positive face angle 22. Negative face angle 23 may be longer than positive face angle 22, for example so that tip root 24 is ahead of cutting edge 21 in the cutting direction \vec{1}. The width of tip root 24 may fit substantially precisely in between side walls 10 of the already cut kerf, for example, such that root 24 may be in contact with walls 10 when moving in between them. Thus, for example, tip root 24 may guide tip 20 together with cutting edge 21 to follow the existing cutting plane, e.g. the plane of walls 10, and therefore, for example, to create straight and accurate cutting line.

In the cutting process, for example since tip root 24 may be ahead of cutting edge 21 in the cutting direction \vec{1}, cutting edge 21 may be pulled by tip root 24 wherein both cutting edge 21 and root 24 may be integral with tip 20. Therefore, for example, deviations of cutting tip 20 from the cutting plane may be greatly reduced or substantially prevented. Therefore, swinging and vibrating movement of tip 20 may be greatly reduced or substantially avoided which may result in a thinner cutting kerf and better surface quality. This effect has high importance for all kind of thin cutting blades (circular saws, band saws and hack saws), where the saw body is thin and relatively flexible.

Farther, since the width of tip root 24 may fit substantially exactly in between side walls 10 of the already cut kerf, the facets 25 of tips 20 may be held by the already cut surfaces 10. Therefore, vibrations of tips 20 may be damped and/or stabilization of cutting tips 20 may be obtained.

In some embodiments of the present invention tip 20 may include additional and/or other face angles further to face angles 22 and 23 as far as tip root 24 may be ahead of cutting edge 21 in the cutting direction \vec{1}. In some embodiments of the present invention tip 20 may be at least partially curved and/or rounded, as far as tip root 24 may be ahead of cutting edge 21 in the cutting direction \vec{1}.

Since tip root 24 may be in contact with walls 10 when moving in between them, high friction and heat may be resulted. Tip 20 may include a side release angle 12 of facet 25, for example, in order to reduce the resulted heat. Side release angle 12 may have a projected inclination direction \vec{3} on the plane of the cutting direction \vec{1} and the feeding direction \vec{2} of the material into saw 28. Projected inclination direction \vec{3} may be between feeding direction \vec{2} and the perpendicular to negative face angle 23. As the projected inclination direction \vec{3} of release angle 12 is closer to feeding direction \vec{2}, the heat which may be resulted by contact between walls 10 and tip 20 may be reduced, for example, because there may be less contact between facets 25 and walls 10. However, as the projected inclination direction \vec{3} of release angle 12 is closer to feeding direction \vec{2}, the cutting accuracy may be reduced.

Therefore, in saws where the tip has relatively short time for cooling between the kerfs, for example, frame saws and circular saws, the projected inclination direction \vec{3} of release angle 12 may be closer to the feeding direction \vec{2} or to the center of the saw in circular saws. As shown in FIG. 9, facet 25 may have projected inclination direction \vec{3} substantially parallel to the feeding direction \vec{2}.

However, in saws where the tip has relatively long time for cooling between the kerfs, for example, band saws, the projected inclination direction \vec{3} of release angle 12 may be closer to the perpendicular to the negative cutting angle 23.

Reference is now made to FIG. 10, which is a schematic illustration of tip 20 according to the present invention as described above, with alternative facet 26 instead of facet 25 shown in FIG. 9. Facet 26 may have projected inclination direction \vec{3} substantially parallel to the perpendicular to the negative cutting angle 23 and thus, for example, may have a release angle close to zero in the cutting direction. Therefore, for example, facet 26 may keep tip 20 straight with walls 10 of the already cut kerf. This may overcome instability of tip 20 which may be caused by the saw flexibility. The saw flexibility is usually a main disadvantage of band saws, which may be overcame by facet 26.

Reference is now made to FIG. 11, which is a schematic illustration of cutting tip 30 according to the present invention from several angles. Cutting tip 30 may include positive face angle 30b, negative face angle 30a, a sharp cutting edge 39 and tip root 34, located ahead of cutting edge 39 in the cutting direction, as described above with reference to FIG. 10. Cutting edge 39 may be located at the edge of positive face angle 30b.

Negative face angle 30a may include a side release angle 35 and a side release angle 36. Side release angle 35 may have a projected inclination direction 3\vec{2}, parallel to the feeding direction of the material into saw 38. Side release angle 35 may be implemented in the portion of face angle 30a located ahead of cutting edge 39 in the cutting direction 3\vec{1}, i.e. from tooth root 34 to cutting edge front line 37. Side release angle 36 may have a projected inclination direction 3\vec{3}, opposite to the cutting direction 3\vec{1}. Side release angle 36 may be implemented in the portion of face angle 30a located behind the front of cutting edge 39 in the cutting direction 3\vec{1}, i.e. from cutting edge front line 37 to the meeting point of negative face angle 30a and positive face angle 30b.

Side release angles 25, 35 and/or 36 may enable saw body 28 and/or 38 to be thicker in the front, e.g. close to the sawing area, than in the rest of the body of saws 28 and/or 38. Therefore, saws 28 and/or 38 may bear higher forces and/or tension at the cutting area.

What is claimed is:

1. A system for thin cutting, the system comprising:
a saw unit; and
a guiding unit comprising at least one pair of guides, where each guide of the pair is configured to impose pressure on corresponding two opposite pre-cut longitudinal edges of a block of raw material and to guide said block of raw material into said saw unit.

2. A system according to claim 1, wherein said pair of guides is located at said two opposite longitudinal edges of said block.

3. A system according to claim 1, wherein said saw unit comprises at least one band saw.

4. A system according to claim 1, wherein said saw unit comprises a frame saw.

5. A system according to claim 1, wherein each of said pre-cut longitudinal edges is one of pre-cut rebates and pre-cut planes.

6. A system according to claim 1, wherein said guiding unit further comprising supporting guides to fit into corresponding longitudinal pre-cuts in said block of raw material.

7. A system according to claim 1, wherein said guides are disc-shaped.

8. A system according to claim 1, wherein said guides are rotatable.

9. A system according to claim 1, wherein said guides impel said block towards said saw unit.

10. A system according to claim 1, wherein said at least one pair of guides is installed on a shaft.

11. A system according to claim 10, wherein said at least two guides are rotatable about a longitudinal axis of said shaft.

12. A system according to claim 10, wherein said guiding unit further comprising space rings installed on said shaft to fix distance between said guides.

13. A system according to claim 12, wherein said space rings are rotatable about a longitudinal axis of said shaft, and are in contact with said block to impel said block towards said saw unit when rotating.

14. A system according to claim 1, wherein said at least one pair of guides comprise a plurality of pairs of guides connected together to guide plurality of blocks to be cut together.

15. A cutting tip for thin cutting saw, the cutting tip comprising:
a cutting edge having a positive face angle;
a root of said tip having a negative face angle, located ahead of said cutting edge in the cutting direction.

16. A cutting tip according to claim 15, wherein a width of said root fits in between side walls of cut kerf already cut by said cutting tip such that said root being in slight contact with said walls when moving in between them.

17. A cutting tip according to claim 15, wherein each facet of said cutting tip has a first and second side release angles, wherein said first side release angle is located ahead of said cutting edge in the cutting direction and has an inclination direction parallel to the feeding direction of raw material into said saw, and wherein said second side release angle is located behind a front of said cutting edge in the cutting direction and has an inclination direction opposite to the cutting direction.

18. A method for thin cutting, the method comprising:
guiding a block of raw material into a saw unit by imposing pressure by at least one pair of guides on corresponding two opposite pre-cut longitudinal edges of a block of raw material.

19. A method according to claim 18, comprising, before the step of guiding, the step of pre-cutting said pre-cut longitudinal edges in said block.

20. A method according to claim 18, wherein said guiding is further by supporting guides configured to fit into corresponding longitudinal pre-cuts in said block of raw material.

21. A method according to claim 19, wherein said pre-cutting comprises pre-cutting of longitudinal pre-cuts into which supporting guides are configured to fit.
